(19) United States
(12) Patent Application Publication
(10) Pub. No.: US 2002/0154403 A1
(43) Pub. Date: Oct. 24, 2002

(54) Photonic crystal optical isolator

(76) Inventor: Donald M. Trotter, JR., Newfield, NY (US)

Correspondence Address: CORNING INCORPORATED, SP-TI-3-1, CORNING, NY, 14831

(21) Appl. No.: 09/840,712

(22) Filed: Apr. 23, 2001

(51) Int. Cl. G02B 5/30

(52) U.S. Cl. 359/484; 359/483

(57) ABSTRACT

An optical isolator includes a magneto-optical substrate exhibiting the Faraday effect and a pair of photonic crystal polarizers formed on opposite surfaces of the magneto-optical substrate and oriented relative to each other. The photonic crystal polarizers permit propagation of a selected polarization component of an input beam.

### BACKGROUND OF INVENTION

1. Field of the Invention

The invention relates to an integrated optical isolator for suppressing back reflection of a light wave emitted from a semiconductor laser diode.

2. Background Art

Fiber-optic systems generally include a transmitter that converts electronic data signals to light signals, an optical fiber that guides the light signals, and a receiver that captures the light signals at the other end of the fiber and converts them to electrical signals. For high-speed data transmission or long-distance applications, the light source in the transmitter is usually a semiconductor laser diode. The transmitter pulses the output of the laser diode in accordance with the data signal to be transmitted and sends the pulsed light into the optical fiber. Some of the light sent into the optical fiber may be reflected back from the fiber network. This reflected light affects the operation of the laser diode by interfering with and altering the frequency of the laser output oscillations. For this reason, an optical isolator is typically provided between the laser diode and the optical fiber to prevent the back-reflection from reaching the laser diode.

Optical isolators are generally classified as polarization-independent or polarization-dependent. Polarization-dependent optical isolators provide a power light output that depends on the polarization state or degree of polarization of the input beam, whereas polarization-independent optical isolators provide the same power light output irrespective of the polarization state or degree of polarization of the input beam. Polarization-dependent optical isolators that use a combination of linear polarizers and Faraday rotators are well known. Polarization-independent optical isolators using a combination of polarization beam splitters, typically made of birefringent crystals such as rutile or calcite, and Faraday rotators are well known.

FIG. 1 shows an example of a polarization-dependent optical isolator 2 which includes a Faraday rotator 4 sandwiched between an entrance polarizer 6 and an exit analyzer polarizer 8. The exit analyzer polarizer 8 is oriented at 45° relative to the entrance polarizer 6. The Faraday rotator 4 and the polarizers 6, 8 are surrounded by a permanent magnet 10, which applies a magnetic field to the Faraday rotator 4. Depending on the polarization state of the input beam 12, an amount of the input beam 12 passes through the entrance polarizer 6. The magnetic field applied by the magnet 10 in concert with the Faraday rotator 4 causes the polarization plane of the input beam 12 to rotate 45° within the Faraday rotator 4. The beam exits the optical isolator 2 through the analyzer polarizer 8, as indicated at 14. Reflected light traveling in the reverse direction is first polarized at 45° by the analyzer polarizer 8. Because the Faraday effect is non-reciprocal, the reflected light is rotated an additional 45° by the Faraday rotator 4 and then blocked by the entrance polarizer 6.

To ensure desired characteristics of the optical isolator 2, the polarizers 6, 8 must be precisely aligned with Faraday rotator 4 so that the appropriate angle is formed between the polarizers 6, 8. Because of the alignment requirements, the assembly process of the optical isolator 2 is somewhat labor-intensive. Some manufacturers use manual methods for assembly followed by soldering, gluing, or welding techniques to fix the individual components in place. The materials used to fix the components in place can present reliability problems in terms of micro movement of the components in hostile operating conditions.

### SUMMARY OF INVENTION

In one aspect, the invention relates to an optical isolator which comprises a magneto-optical substrate exhibiting the Faraday effect and a pair of photonic crystal polarizers formed on opposite surfaces of the magneto-optical substrate and oriented at an angle relative to each other, the photonic crystal polarizers permitting propagation of a selected polarization component of an input beam.

In another aspect, the invention relates to a method for fabricating an integrated optical isolator which comprises forming a periodic pattern on both surfaces of a magneto-optical substrate exhibiting the Faraday effect and depositing alternating layers of two materials having different optical constants on both surfaces of the magneto-optical substrate.

Other aspects and advantages of the invention will be apparent from the following description and the appended claims.

### BRIEF DESCRIPTION OF DRAWINGS

FIG. 1 is a schematic of a prior art polarization-dependent optical isolator.

FIG. 2 is a three-dimensional view of a prior art photonic crystal polarization splitter.

FIG. 3 illustrates an optical isolator according to an embodiment of the invention.

FIG. 4 shows a system for fabricating the optical isolator shown in FIG. 3 in accordance with one embodiment of the invention.

FIG. 5 shows a system for fabricating the optical isolator shown in FIG. 3 in accordance with another embodiment of the invention.

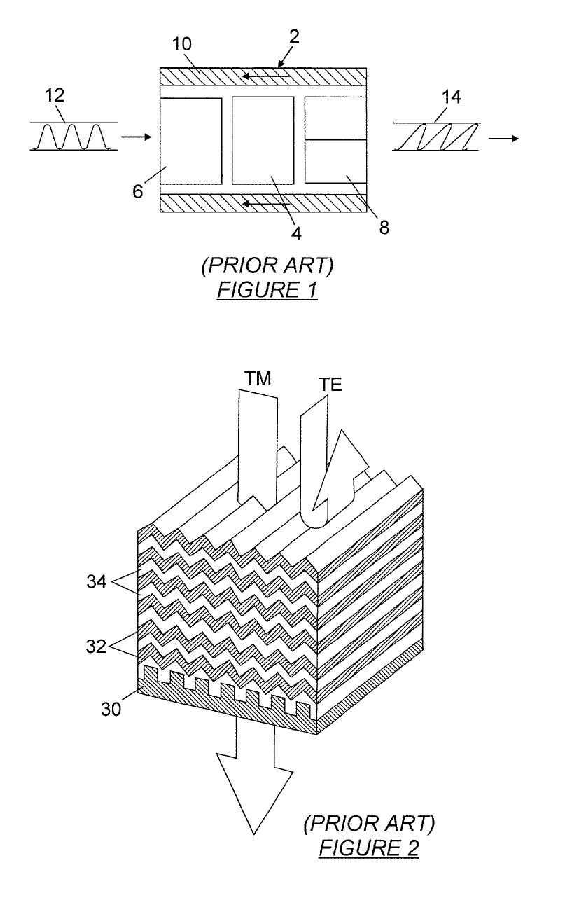

### DETAILED DESCRIPTION

Embodiments of the invention provide a polarization-dependent optical isolator and a method of fabricating the same. The optical isolator comprises two photonic crystal polarizers formed on both sides of a Faraday rotator. Photonic crystals are artificial multidimensional dielectric periodic structures that have a band gap that forbids propagation of a certain frequency range of light. Ohtera et al. in their paper entitled “Photonic crystal polarization splitters” (see Electronics Letters, Vol. 35, No. 15, Jul. 22, 1999) disclose a two-dimensional photonic crystal which functions as a polarization splitter for near-infrared wavelengths (1.3 to 1.5 μm) at normal incidence. FIG. 2 shows a schematic of the photonic crystal polarization splitter. The polarization splitter consists of a-Si layer 32 and SiO₂ layer 34 alternately stacked on a substrate 30 with periodically-arrayed grooves. The anisotropy of the photonic band structure yields several frequency ranges where only one of the transverse magnetic field (TM) and transverse electric field (TE) modes is transmitted. For example, in FIG. 2, the TM radiation is transmitted and the TE radiation is reflected.

The optical isolator of the present invention uses photonic crystal polarization splitters such as disclosed in Ohtera et al., supra, as photonic crystal polarizers. The photonic crystals polarizers are properly oriented relative to each other to achieve the optical isolator function. The first photonic crystal polarizer on the input side of the Faraday rotator admits the passband polarization component of an incident light which is launched at the appropriate frequency. The passband component rotates within the Faraday rotator and propagates through the second photonic crystal polarizer on the output side of the Faraday rotator. Reflected light propagates through the second photonic crystal polarizer, rotates within the Faraday rotator in the same direction as the incident passband component, and is then blocked by the first photonic crystal polarizer. In a preferred embodiment, the photonic crystal isolators are directly formed on the Faraday rotator to achieve an integrated optical isolator. The integrated optical isolator could be manufactured in large wafers and then subsequently diced into individual isolators.

Ohtera et al., supra, describe a method for stacking a-Si and SiO₂ layers 32, 34 on the grooved substrate 30. The method is based on radio-frequency (RF) bias sputtering. RF bias sputtering is a combination of RF sputter deposition and sputter etching. The deposition parameters such as gas pressure, main and bias RF powers, and bias voltage schedule for appropriate etching are set such that the saw-toothed profile of the layers 32, 34 is automatically established and then duplicated in subsequent layers. Kawakami et al. in their paper entitled “Mechanism of shape formation of three-dimensional periodic nanostructures by bias sputtering” (see Applied Physics Letters, Vol. 74, No. 3, Jan. 18, 1999, pages 463-465) describe the mechanism of the self-shaping effect of bias sputtering.

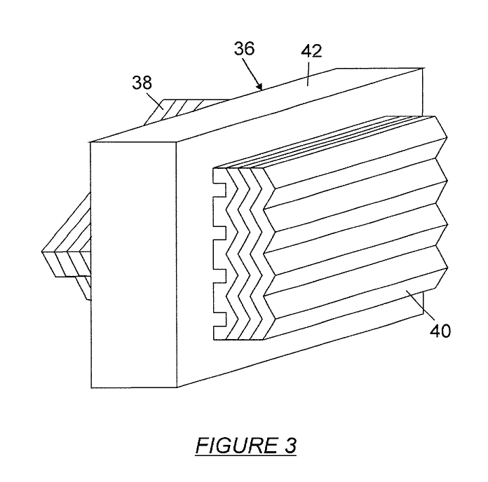

Various embodiments of the invention will now be described with reference to the accompanying drawings. FIG. 3 shows an optical isolator 36 according to an embodiment of the invention. The optical isolator 36 includes photonic crystal polarizers 38, 40 formed on both surfaces of a Faraday rotator 42 with 45° rotation. In a preferred embodiment, the photonic crystal polarizers 38, 40 have a structure similar to that disclosed in Ohtera et al., supra. The Faraday rotator 42 is made of a magneto-optical material exhibiting the Faraday effect with a high Verdet constant, e.g., bismuth-substituted rare-earth iron garnet. Preferably, the garnet is of the so-called “latching” type which does not require a bias magnet. However, a non-latching garnet may also be used. In this case, an external magnet will be needed to apply a magnetic field to the Faraday rotator 42. The photonic crystal polarizers 38, 40 are oriented at 45° relative to each other to achieve the isolator function. In a preferred embodiment, the photonic crystal polarizers 38, 40 are formed directly on the Faraday rotator 42 using, for example, vacuum deposition process. Alternatively, the photonic crystal polarizers 38, 40 may be bonded to the surfaces of the Faraday rotator 42 by an optical adhesive.

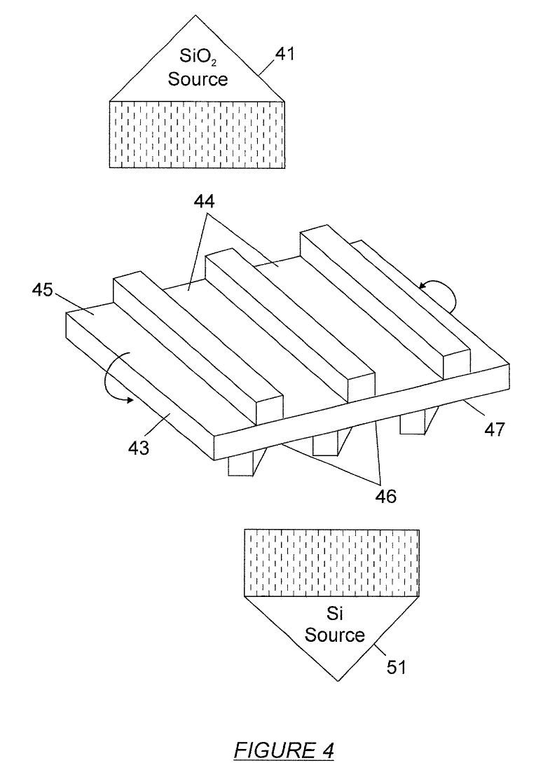

A process for fabricating an integrated optical isolator 36 starts with forming periodically-arrayed grooves on both surfaces of a Faraday rotator material. FIG. 4 shows periodically-arrayed grooves 44, 46 formed on surfaces 45, 47, respectively, of a Faraday rotator substrate 43. The period and dimensions of the grooves 44, 46 are selected based on the desired operating wavelength. Methods for calculating photonic crystal properties have been published. See, for example, Tyan et al., Journal of the Optical Society of America A, 14(7) 1627(1997) and Robertson et al., Journal of the Optical Society of America B, 10, 322(1993). The grooves 44 are oriented at 45° relative to the grooves 46. The periodic grooves 44, 46 may be formed on the surfaces 45, 47, respectively, using processes such as electron beam lithography followed by dry etching or nano-imprint lithography. EBL involves scanning a beam of electrons across a surface covered with a resist film that is sensitive to those electrons. Nano-imprint lithography is an embossing technology and is described in U.S. Pat. No. 5,772,905 issued to Chou.

The Faraday rotator substrate 43 with the periodic grooves 44, 46 formed thereon acts as a seed layer for growing the photonic crystal polarizers (38, 40 in FIG. 3). Two materials with different indices of refraction are alternately deposited on the Faraday rotator substrate 43 using a suitable arrangement of vacuum deposition sources 41, 51, such as sputter guns, and means of alternately exposing the surfaces of the Faraday rotator substrate 43 to the vacuum deposition sources. A-Si and SiO₂ are examples of materials that can be alternately deposited on the Faraday rotator substrate 43. In general, the materials deposited on the Faraday rotator substrate 43 should have high transparency in the operating wavelength range of interest. Further, the two materials from which the alternating layers are formed should have a large difference in refractive index in the operating wavelength range of interest. Selection of such materials is well-known to those skilled in the art.

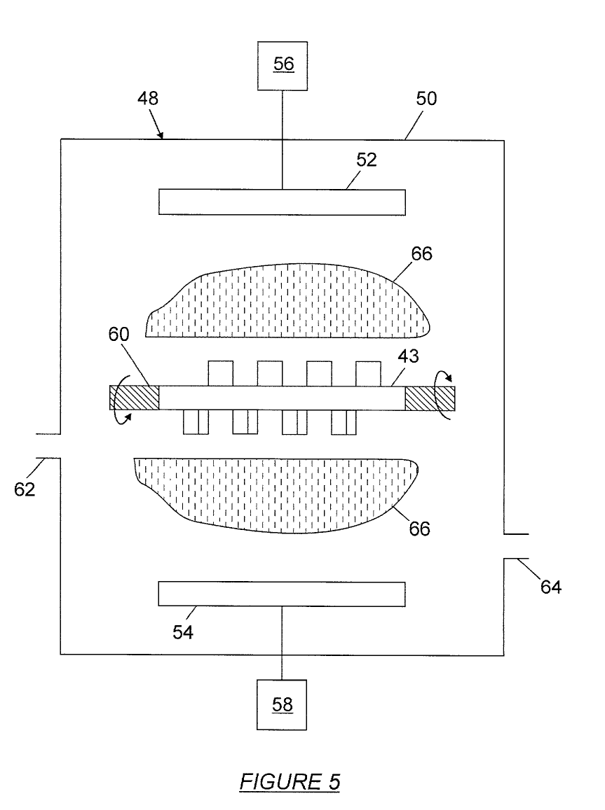

FIG. 5 schematically shows a system 48 for depositing two materials continuously and simultaneously on the surfaces of the Faraday rotator substrate 43 using RF bias sputtering. For the sake of argument, the materials deposited on the Faraday rotator substrate 43 are presumed to be a-Si and SiO₂. However, other types of materials can be used. The system 48 includes a vacuum chamber 50 having sputter targets 52, 54 made of the material to be deposited. For example, the sputter target 52 could be made of a-Si, and the sputter target 54 could be made of SiO₂. The sputter targets 52, 54 are connected to RF power sources 56, 58, respectively. A substrate holder 60 is mounted between the sputter targets 52, 54. The substrate holder 60 supports the Faraday rotator 43. The substrate holder 60 may be rotatably supported within the vacuum chamber 50. The substrate holder 60 may also include means for flipping the Faraday rotator substrate 43 so that the surfaces of the Faraday rotator substrate 43 are alternately exposed to the sputter targets 52, 54. A heater (not shown) may be provided to heat the substrate holder 60 during deposition.

The vacuum chamber 50 has an inlet 62 for receiving plasma-generating gases such as argon. The vacuum chamber 50 also has an outlet 64 which is connected to a vacuum pump (not shown). The vacuum pump is used to maintain desired pressures in the vacuum chamber 50 and to evacuate the vacuum chamber 50. In operation, a plasma-generating gas, e.g., argon, is introduced into the vacuum chamber 50 through the inlet 62 and the sputter guns 52, 54 are started. Argon plasma 66 is generated within the chamber 50. The plasma 66 contains argon ions, electrons, and neutral argon atoms. The argon ions bombard the sputter targets 52, 54, dislodging atoms from the targets. The atoms deposit on the Faraday rotator substrate 43 to form film. The arrival angle distribution of the sputtering particles is generally described by cosⁿφ distribution, where φ denotes the angle from the vertical and n denotes the parameter of diffusion profile. The flow of particles is isotropic for n=0 and normal to the target for n=∞. The normal component of flux striking the substrate determines the deposition or growth rate.

During deposition, the Faraday rotator substrate 43 is periodically flipped over, as indicated by the arrows, to allow alternating layers of a-Si and SiO₂ to be deposited on both of its surfaces. A RF bias is separately applied to the substrate holder 60, which allows sputter etching of the layers with charged argon ions. In sputter etching, the argon ions bombard the layers of material being deposited, causing atoms to physically dislodge from the layers. Sputter etching together with sputter deposition result in the saw-toothed profile of the polarization crystal polarizers (38, 40 in FIG. 3).

Using the process described above, or other suitable process, photonic crystal polarizers can be formed on a large Faraday rotator substrate. The substrate can then be diced into individual optical isolators. It should be noted that the registration of the polarizers (38, 40 in FIG. 3) on the surfaces of the Faraday rotator (42 in FIG. 3) is not critical; only the relative angle of the two polarizers (38, 40 in FIG. 3) is important.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An optical isolator, comprising:
a magneto-optical substrate exhibiting the Faraday effect; and
a pair of photonic crystal polarizers formed on opposite surfaces of the magneto-optical substrate and oriented at an angle relative to each other, the photonic crystal polarizers permitting propagation of a selected polarization component of an input beam.

2. The optical isolator of claim 1, wherein each photonic crystal polarizer includes two materials with different optical constants arranged in alternating layers.

3. The optical isolator of claim 2, wherein the two materials are amorphous silicon and silica.

4. The optical isolator of claim 3, wherein the layers have a saw-toothed profile.

5. The optical isolator of claim 1, wherein the photonic crystal polarizers are oriented at 45° relative to each other.

6. The optical isolator of claim 1, wherein the photonic crystals are formed directly on the surfaces of the magneto-optical substrate.

7. An optical isolator, comprising:
a magneto-optical substrate exhibiting the Faraday effect; and
a pair of photonic crystal polarizers formed on opposite surfaces of the magnetooptical substrate and oriented at an angle relative to each other, each photonic crystal polarizer including two materials with different optical constants arranged in alternating layers, each photonic crystal polarizer permitting propagation of a selected polarization component of an input beam.

8. An optical isolator, comprising:
a Faraday rotator substrate with a 45° rotation;
a photonic crystal polarizer formed on an input side of the Faraday rotator substrate;
a second photonic crystal polarizer formed on an output side of the Faraday rotator substrate, the second photonic crystal polarization splitter oriented at an angle of 45° relative to the first photonic crystal polarizer.

9. A method for fabricating an integrated optical isolator, comprising:
forming a periodic pattern on both surfaces of a magneto-optical substrate exhibiting the Faraday effect; and
depositing alternating layers of two materials having different optical constants on both surfaces of the magneto-optical substrate.

10. The method of claim 9, wherein the materials are deposited by radio-frequency bias sputtering.

11. The method of claim 9, wherein the materials include amorphous silicon and silica.

12. The method of claim 9, wherein the materials are simultaneously deposited on both surfaces of the magneto-optical substrate.
